(19) United States
(12) Patent Application Publication
(10) Pub. No.: US 2004/0058179 A1
(43) Pub. Date: Mar. 25, 2004

(54) Cellulose ester film and producing method thereof

(75) Inventors: Hidekazu Yamazaki, Kanagawa (JP); Toshikazu Nakamura, Kanagawa (JP); Hiroshi Miyachi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/663,792

(22) Filed: Sep. 17, 2003

(30) Foreign Application Priority Data
Sep. 19, 2002 (JP) 2002-273896

(51) Int. Cl. B32B 23/04

(52) U.S. Cl. 428/532

(57) ABSTRACT

The dope prepared from a mixture solvent and solid contents such as cellulose ester and additives is cast on a drum cooled to −5° C. to form a gel-like film. The gel-like film is peeled off from the drum. Tension of 60 kg/m is applied to the gel-like film in the widthwise direction thereof and the temperature of the gel-like film is kept 120° C., when the content of the solvent to the solid contents in the gel-like film is in a range of 100 wt. % to 20 wt. %. Further the gel-like film is dried to be a cellulose ester film having 40 μm thickness. The IR spectrum of the cellulose ester film has a peak in a range of 520 cm⁻¹ to 480 cm⁻¹ which indicates the crystallization of the polymer. The cellulose ester film has tear strength of 12 g, Rth of 42 nm and Re of 1.2 nm. As crystallization of the polymer proceeds, the cellulose ester film has sufficient strength and optical properties.

### BACKGROUND OF THE INVENTION

1. Field of the Invention

The present invention relates a thin cellulose ester film having sufficient strength and a producing method thereof.

2. Explanations of the Prior Arts

Recently, the demands for a transparent plastic film as optical materials are on the increase. For instance, there are a protective film for a polarizing filter used in a liquid crystal display (LCD), an optical compensation film such as a retardation film, a plastics substrate, a base film for photography, a cell for moving image, an optical filter, and an OHP film.

Moreover, the LCD has been widely used for a personal computer, a word processor, a modem for portable telephone, a TV, a digital camera, a movie camera, and so forth as the LCD becomes excellent in quality and portability. A polarizing filter is indispensable for the LCD to display an image. Similarly, it is required that the transparent plastic film as the protective film has further high quality.

Films for optical use such as the protective film for the polarizing filter is required to have various properties for quality level of resolution and contrast. As these properties, there are high transparency, low optical anisotropy, flatness, easiness of surface treatment, high durability (dimensional stability, heat and moisture resistance and water resistance), contaminant-free inside and on the film, scar-free on the surface, good scratch resistance, suitable stiffness and suitable water permeability.

As film material having such properties, there are cellulose esters, norbornen resin, acrylic resin, polyarylate resin, polycarbonate resin and the like. However, in view of productivity and cost, cellulose ester is mainly used. In particular, the cellulose triacetate film is favorably used in optical products due to its properties of extremely high transparency, small optical anisotropy, and a low value of retardation (Rth).

In order to produce these films, there are several film base producing methods, such as a solution casting method, a melt extrusion method, and a calendering method. However, the solution casting method is especially suitable to obtain the film which is excellent in flatness and has the low optical anisotropy.

This method is disclosed in Japan Institute of Invention and Innovation (JIII) Journal of Technical disclosure (See 2001-1745, for instance). In the method, a solution (referred as dope hereinafter) into which polymer is dissolved is cast on a substrate from a casting die, dried and peeled to be a continuous film. The film produced from this method is superior in optical isotropy, thickness uniformity, and quantity of contaminants to the film produced in the melt extrusion method. Therefore, the former film is used for optoelectronics, such as the protective film for a polarizing filter, a birefringence film, and a transparent conductive film. As the substrate, there are a belt and a rotary drum, for instance. The substrate is often used as a generic term of the belt and the rotary drum in the description of the present invention.

Recently, while development of electronic devices of compact size proceeds, the protective film for a polarizing filter and the cellulose ester film for optical use is demanded to become thinner. However, a value of retardation (Rth) and a tear strength is also decreased proportional to the thickness of the film. Further, some types of the produced film have a value of unfavorable retardation in-plane (Re). Accordingly, when the thin film like the protective film for a polarizing filter and the cellulose ester film are used for a wide viewing angle film, which is a kind of optical functional film, the retardation in thickness direction (Rth) becomes too small to develop to enlarge a field angle sufficiently. Further, the tear strength of the film sometimes decreases too much to have sufficient strength in case that the above film is used for various products.

### SUMMARY OF THE INVENTION

A main object of the present invention is to provide a thin cellulose ester film with excellent optical property and strength, and its producing method.

Another object of the present invention is to provide various optical products made of the cellulose ester film.

To attain the above and other objects, the cellulose ester film of the present invention has a peak of infrared absorption spectrum in the wavenumber range of 520 cm⁻¹ to 480 cm⁻¹. Furthermore, a tear strength of the cellulose ester film of the present invention is at least 6 g.

In the above cellulose ester film, retardation in thickness direction (Rth) is preferably at least 35 nm. Retardation in-plane (Re) is preferably in a range of −50 nm to 5 nm when the feeding direction in producing the cellulose ester film is a positive direction. Preferably the thickness of the above cellulose ester film is in a range of 35 μm to 65 μm. Further, it is preferable to use cellulose acylate, especially cellulose triacetate (TAC).

The producing method of the cellulose ester film of the present invention includes the following steps. Firstly, a dope that containing a solvent and solid contents such as cellulose ester is cast on a substrate from a casting die to form a gel-like film. Secondly, the gel-like film is peeled from the substrate. Thirdly, temperature of the gel-like film is adjusted in a range of 80° C. to 140° C. when the content of the solvent is in a range of 20 wt. % to 100 wt. % to the solid contents. And finally, in another producing method, there includes a step that tension of 25 kg/m to 250 kg/m is applied to the gel-like film in a widthwise direction of the gel-like film when the content of the solvent is in a range of 20 wt. % to 100 wt. % to the solid contents. Note that it is preferable to apply tension in a range of 25 kg/m to 250 kg/m to the gel-like film while keeping the temperature of the gel-like film at a range of 80° C. to 140° C.

The producing method of the cellulose ester film of the present invention includes a cooling step to cool the dope at most 5° C. after the dope is cast. By adding the cooling step, the cellulose ester film has a peak in a range of 520 cm⁻¹ to 480 cm⁻¹ in the infrared absorption spectrum, the tear strength is at least 6 g, and the retardation in thickness direction (Rth) is at least 35 nm.

Further, it is preferable to measure infrared absorption spectrum of the film on-line during producing in order to adjust temperature or tension of the gel-like film according to the peak intensity in a range of 520 cm⁻¹ to 480 cm⁻¹.

The gel-like film may have multi-layer structure, which includes that plural dopes are simultaneously cast on a substrate, or plural dopes are sequentially cast on the substrate. In order to achieve this, a multimanifold casting die having plural manifolds, a casting die having a feed block on an upstream side, or plural monolayered casting dies may be used.

In the cellulose ester film, it is preferable to cast the dope in order that the thickness of the cellulose ester film is in a range of 20 μm to 120 μm, particularly in a range of 35 μm to 65 μm.

The cellulose ester film of the present invention is used for a protective film for a polarizing filter, an optical functional film, a polarizing filter, a liquid crystal display (LCD), and so forth.

According to the present invention, the degree of crystallization in the cellulose ester film is easily detected by measuring whether there is a peak of the infrared absorption spectrum or not in a range of 520 cm⁻¹ to 480 cm⁻¹. In case there is the peak in the range, due to progress of crystallization of the polymer, the film has sufficient tear strength regardless of film thickness. Moreover, it is possible to prevent a value of retardation in thickness direction (Rth) from being decreased as the film becomes thinner, since cellulose ester polymer is orientated owing to crystallization of the film.

According to the method for producing the cellulose ester film of the present invention, the degree of infrared absorption spectrum of the film is measured on-line to adjust temperature or tension of the gel-like film in accordance with the peak intensity of 520 cm⁻¹ to 480 cm⁻¹. As a result, it is possible to produce the film having excellent strength and optical property successively.

### BRIEF DESCRIPTION OF THE DRAWINGS

The above and other objects and advantages of the present invention will become apparent from the following detailed description of the preferred embodiments when read in association with the accompanying drawings, which are given by way of illustration only and thus are not limiting the present invention In the drawings, like reference numerals designate like or corresponding parts throughout the several views, and wherein:

FIG. 1 is a schematic diagram of a film production line in the present invention;

FIG. 2 is a sectional view of a first embodiment of a casting die used in the present invention;

FIG. 3 is a sectional view of a second embodiment of the casting die;

FIG. 4 is a sectional view of a third embodiment of the casting die;

FIG. 5 is a graph illustrating an infrared absorption spectral of the cellulose ester film of the present invention; and

FIG. 6 is a graph illustrating an infrared absorption spectral of the cellulose ester film of the prior art.

### DETAILED DESCRIPTION OF THE EMBODIMENTS

{Cellulose Ester}

Cellulose ester is used as a main material of a film in the present invention. It is particularly preferable to use cellulose acylate, and especially preferable to use cellulose triacetate (hereinafter TAC) whose acetyl value is in a range of 59.0% to 62.5%. A film made of TAC is used as a protective film for a polarizing filter. The protective film for the polarizing filter is excellent in optical properties and dimensional stability. When TAC is used as a raw material, viscosity-average degree of polymerization is preferably in the range of 200 to 400, particularly in the range of 250 to 350, and especially in the range of 270 to 330. Moreover, it is preferable to use a TAC having an average acetyl value of 60% to 62%, especially, its variation is within ±0.2%.

{Solvent}

Any of the known solvents can be used for preparing the dope in the present invention. In particular, it is preferable to use hydrocarbon halides (such as methylene chloride (dichloromethane)), esters, ethers, ketones, and alcohols, but the solvents in the present invention are not limited to them. Otherwise, plural sorts of the solvents may be mixed for preparing the dope. In the present invention, in order to obtain the film in which cellulose ester is crystallized, it is preferable to use dichloromethane, or mixture of methyl acetate and acetone as a good solvent, and to add alcohols as a poor solvent so as to obtain a mixture solvent. The most preferable alcohol is methanol and n-buthanol. The mixture ratio of the good solvent and the poor solvent is preferably from 95 wt. %: 5 wt. % to 70 wt. %:30 wt. %. However, the present invention is not restricted to them. In a mixing method of mixing cellulose ester and the solvent, it is preferable to prepare the mixture solvent from the good solvent and the poor solvent, and thereafter cellulose ester is added to the mixture solvent. However, the mixing method is not restricted to this description.

{Additives}

Any of the known additives may be added to the dope. As the additives, there are plasticizers, ultraviolet stabilizers including UV absorbent, matting agents, and the like. However, the additives are not limited to them. Furthermore, talc may be added as the additives to the dope. These additives may be mixed during the dope preparation. Otherwise, after preparing the dope, the additives may be mixed to the dope which is fed in a feed line with a static mixer. In the present invention, crystallization proceeds in the film. Accordingly, the film in the present invention is harder than in the general method.

For easy treatment of the film, it is preferable that cellulose ester, the raw material, contains plasticizer in ratio of 8 wt. % to 20 wt. % to cellulose ester in the dope, particularly 10 wt. % to 18 wt. %, and especially 12 wt. % to 16 wt. %. Furthermore, when Triphenyl phosphate (TPP), Biphenyl diphenyl phosphate (BDP) are used as the plasticizer, the produced cellulose ester film has flexibility while keeping its strength, such that the treatment of the film is easier. However, the plasticizers are not restricted in them.

{Preparation of Dope}

In order to dissolve the polymer and additives to the solvent, there are some dissolving methods which are known. In the methods, the dope is prepared. Thereafter, the foreign particles in the dope are usually removed with a filter. As the filter, there are several known filter materials, such as filter paper, filter cloth, non-woven fabric, meshed metal, sintered metal, porous plate and the like can be used. Filtration prevents the film products from having damages and defaults that are caused by the foreign particles and undissolved particles in the dope.

In the dissolving methods, the dope may be heated to dissolve them moreover. There are several heating methods, such as a method in which the dope is stirred and heated simultaneously in a stationary tank, and a method in which the dope is fed and thereby heated with several kinds of heat exchangers of multi-pipe type or jacket pipe type with static mixer, and the like. Furthermore, a cooling process may be provided after the heating process. Further, while the heating is performed, the pressure in a heating device used in the heating method may become higher, such that the temperature of the dope may become higher than the melting point thereof at normal pressure. Thus, the undissolved particles proceed to prevent a filtration pressure for filtration of the dope from becoming higher and amount of foreign materials in the produced film becomes smaller.

{Method for Producing Film}

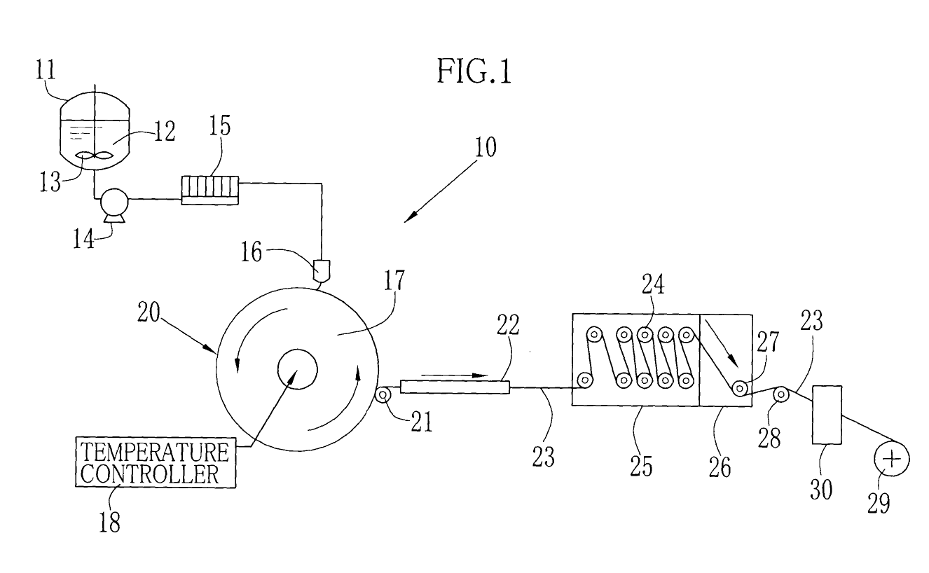

FIG. 1 shows a diagrammatical view of a film production line 10. In this embodiment, TAC is used as a main material of the dope, although other cellulose esters can be used in the present invention. A dope 12 is uniformly mixed by a stirring blade 13 in a mixing tank 11. The dope 12 is fed to a filtration device 15 by a pump 14 to remove impurities, and fed to a casting die 16 at a constant flow rate. Further, the dope 12 is cast on a drum 17, whose temperature is kept at most 5° C. by a temperature controller 18. Upon casting the dope 12, the casting speed is adjusted so as to obtain the produced film after dry in a range of 20 μm to 120 μm thickness, particularly in a range of 35 μm to 65 μm thickness. Concretely, the casting speed is preferably in a range from 45 m/min to 100 m/min. However, it is not limited to this range. The dope 12 on the drum 17 is cooled and dried for more than 5 seconds to form a gel-like film 20, which is dried to be a film 23.

A peeling roller 21 peels off the gel-like film 20, which has been cooled to harden, from the drum 17 and immediately feds to a tenter drier 22. At this time, the gel-like film 20 contains the content of the solvent of 200 wt. % to 300 wt. % to the solid contents (TAC and additives added as needed). The drying of the gel-like film 20 is gradually performed in the tenter drier 22 such that the weight % of the content of the solvent may be 100 wt. % to the solid contents.

In this case, the content of the solvent is kept in the range of 20 wt. % to 100 wt. %, such that the crystallization of TAC is adequately performed. The tenter drier 22 further dries the gel-like film 20 while keeping both sides of the gel-like film 20 to apply tension. The tension is preferably in a range from 25 kg/m to 250 kg/m in a widthwise direction of the gel-like film 20. However, it is not restricted to this range. When the gel-like film 20 is dried by the tenter drier 22, the temperature in the tenter drier 22 is preferably in a range from 80° C. to 140° C. However, the temperature in the tenter drier 22 is not limited to this range. The period the gel-like film 20 passes through the tenter drier 22, namely, the period the tenter drier 22 applies tension and heats the gel-like film 20 is preferably in a range from 1 minute to 5 minutes. However, it is not limited to this range. Thus, the gel-like film 20 forms the film 23, which is fed out from the tenter drier 22.

The film 23 whose crystallization further proceeds can be obtained by gradually changing the tension and the heating temperature of the gel-like film 20 in the tenter drier 22. For instance, the tenter drier is partitioned into many sections to raise temperature of the gel-like film gradually within the above temperature range while increasing tension gradually. As a result, TAC molecules in the gel-like film is easily arranged to raise the degree of crystallization. Although the tenter drier is used to form a film from the gel-like film in the above producing method, the present invention does not limit this.

Further, the film 23 is dried in a dry zone 25 having plural rollers 24 and fed to a cooling zone 26 to cool the film 23. Cooling temperature is not restricted in particular, although it is desirably up to the room temperature. Through the cooling zone 26 by a roller 27, the film 23 is conveyed by a roller 28 and wound by a winding device 29.

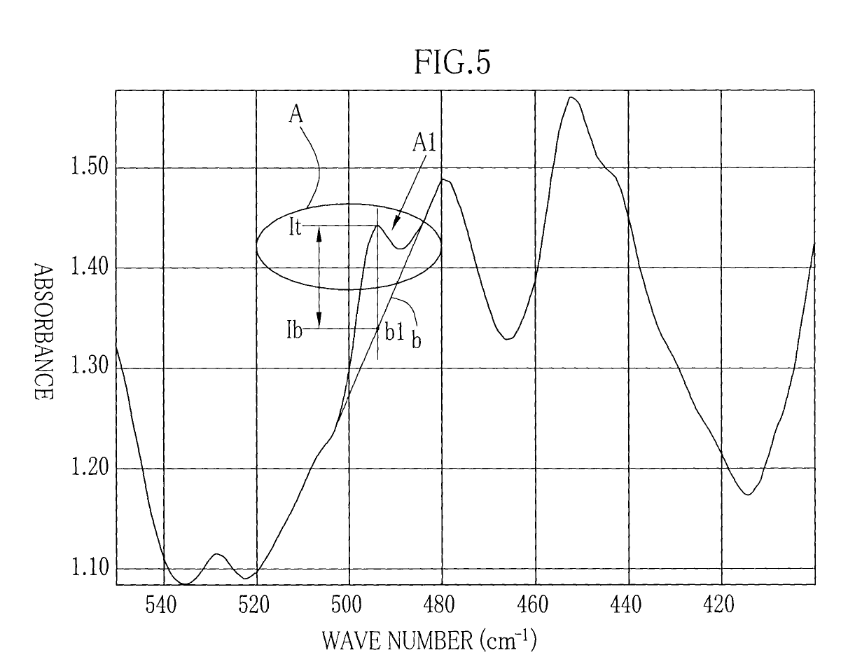

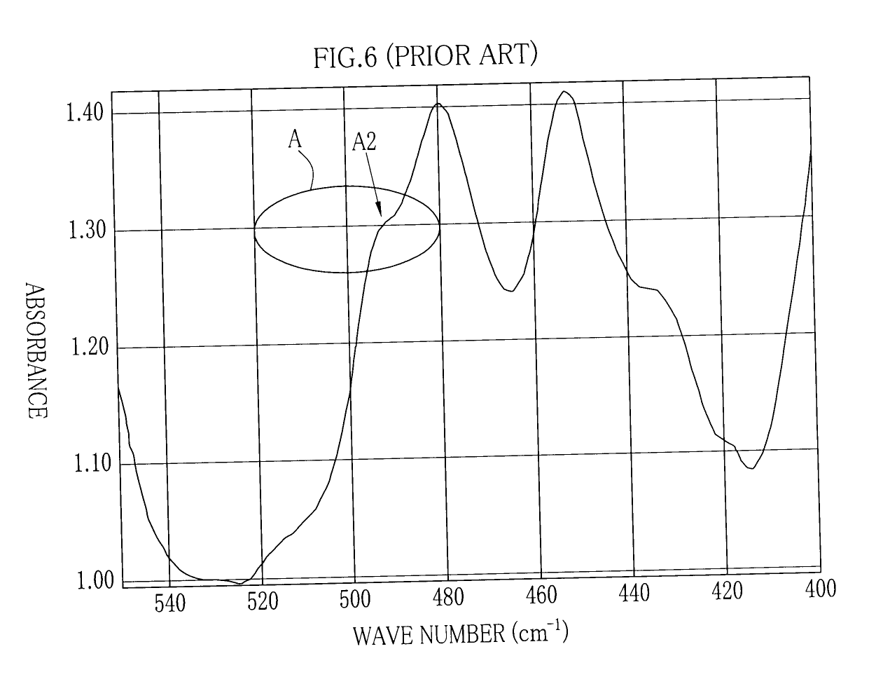

The film production line 10 has an infrared spectrophotometer 30 (commonly called as IR). The infrared spectrophotometer 30 measures infrared absorption spectrum in the wavenumber range of 520 cm⁻¹ to 480 cm⁻¹ of the prewind film 23 (referred as wave number range A). Based on the presence or absence of a spectral peak and intensity in the spectral peak, the degree of crystallization of polymer (cellulose ester) in the film 23 is determined. It is mentioned later in reference with FIGS. 5 and 6. After the degree of crystallization is transmitted to a controlling section that controls the film production line 10 (not shown), the control section controls each device to make the optimum condition for the film production. In order to control each device in a short period, a Fourier transform infrared spectrophotometer (commonly called as FT-IR) is especially preferable.

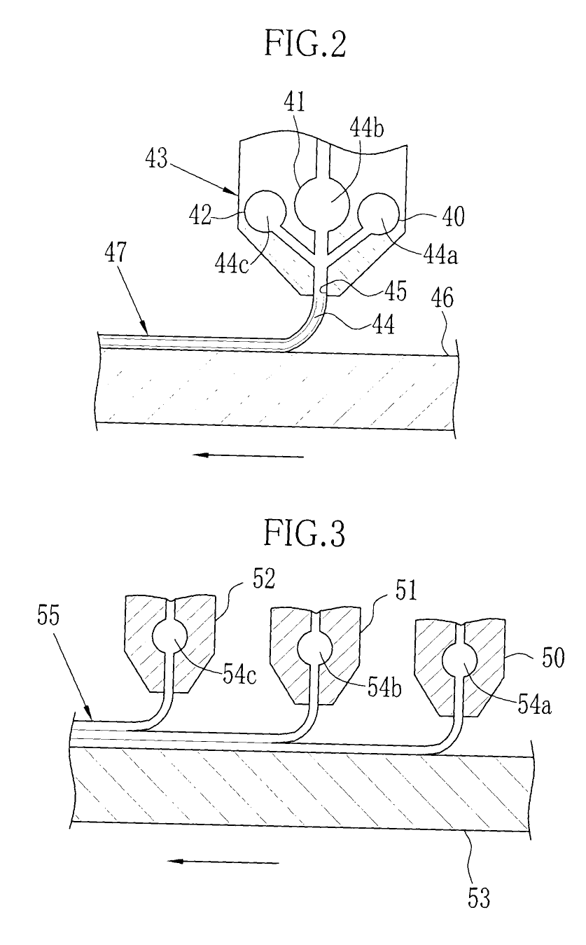

The above embodiment adopts a single-layer casting method in which a single-layer casting die is used to cast a dope. However, the present invention does not restrict in it. A multimanifold type casting die having plural manifolds may be used. In FIG. 2, the multimanifold type casting die is a casting die 43 having three manifolds 40-42. Dopes 44a-44c (supply pipelines are omitted) are supplied to the manifolds 40-42 respectively, then joined in a passage 45. The dopes 44 are cast onto a substrate 46 to form a gel-like film 47. Thereafter, the gel-like film 47 forms a film in the film production line 10 shown in FIG. 1. In FIG. 3, three casting dies 50-52 are arranged on a substrate 53. Dopes 54a-54c are respectively supplied to the casting dies 50-52 through supply pipelines (not shown). The dopes 54a-54c are sequentially cast to form a gel-like film 55. The number of casting die is not limited to the above. Two or more than four casting dies may be arranged on the substrate. The gel-like film 55 forms a film in the film production line 10 shown in FIG. 1.

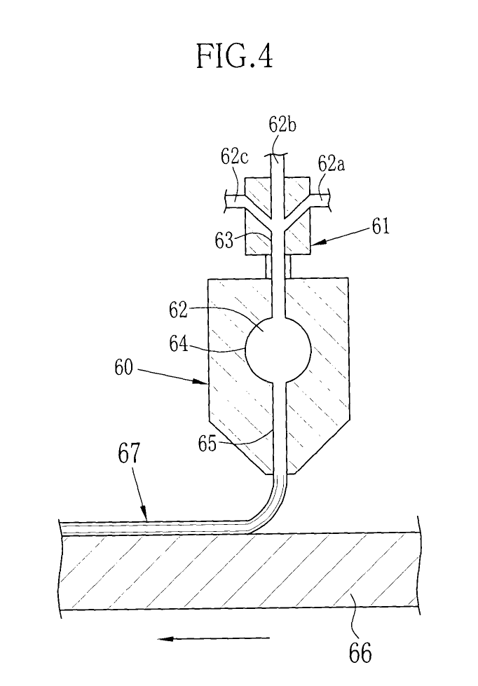

In FIG. 4, a feedblock 61 is attached to a casting die 60 in an upstream side of flow of dopes 62a-62c. The dopes 62a-62c are fed to the feedblock 61, joined in a passage 63, and flow into a manifold 64 of the casting die 60. Each dopes 62a-62c is regulated, flows out from the manifold 64 to have a predetermined width, passes through a slit 65, and is cast on a substrate 66 at the same time. In this way, a gel-like film 67 is formed on the substrate 65. Therefore, the gel-like film 67 forms a film in the film production line 10 shown in FIG. 1. The present embodiment may use both drum and belt as the substrate. Moreover, it is possible to adopt a multi-layer casting method in which synchronous multi-layer casting and sequential multi-layer casting are combined.

The cellulose ester film or especially the cellulose triacetate film obtained by the above producing method is used as the protective film for the polarizing filter. In order to produce the polarizing filter, the two protective films are adhered to respective surfaces of a polarized film composed of polyvinyl alcohol and so forth. Furthermore, the cellulose ester film is used to obtain an optical functional film, such as an optical compensation film in which an optical compensation sheet is adhered to the cellulose ester film, and an antireflection film in which an antiglare layer is formed on the cellulose ester film. These film products may be used to construct a LCD.

{Property of Film}

(1) Tear Strength

When the film obtained in the above described method is used as some products, such as a protective film for a polarizing filter, measurement of tear strength teaches whether the film has sufficient strength or not. Normally, in order to use the film for these products, there is no problem as far as tear strength is 6 grams or above, and the cellulose ester film of the present invention is enough strong as the product.

The film is cut to 64 mm width by 50 mm long to obtain a sample film. The sample film is disposed for more than two hours in a room in which temperature and relative humidity are respectively controlled to 28° C. and 65%. According to the standard of ISO6383/2-1983, a low-load tearing tester is used to measure the weight to tear the sample film in the film casting direction and a widthwise direction thereof. Then an average value is calculated from the data of measurement in these two directions and determined as a tear strength value.

The cellulose ester film of the present embodiment has sufficient strength even if its thickness is decreased to be in a range of 35 μm to 65 μm. The reason for the sufficient strength is that large part of cellulose ester polymer is crystallized in the film. In the present invention, the thickness of the produced film may be in a range of 20 μm to 120 μm. However, the thickness is not limited to the above description.

(2) Retardation in Thickness Direction (Rth)

The cellulose ester film (especially TAC film) produced as above has at least 35 nm of a retardation in thickness direction (it is referred as Rth in the following). In this case, effects to enlarge a viewing angle become wider when used for a wide viewing angle film. The Rth is represented in the following formula (1)

Rth={(nx+ny)/2−nz}×d (1)

Note that “nx”, “ny” and “nz” are refractive indexes in the lengthwise, widthwise, and thickness directions of the film respectively. The refractive indexes “nx”, “ny”, and “nz” are measured with an ellipsometer (a deflect analyzer) at wavelength 632.8 nm. In addition, “d” is an average thickness (nm) of the film.

Normally, the film formed of polymer decreases a value of the Rth as the film becomes thinner. However, the film of the present invention can be thinner with a predetermined value of Rth than a conventional film. The reason is as follows. The cellulose ester (especially TAC) film of the present invention is different from the conventional film in the orientation of the polymer. That is, the polymer crystallizes and the molecules are orientated in the film of the present invention, while polymer molecules are arranged at random in the conventional film. The orientation influences the optical property and makes the degree of polarization along a specific axis of the film large. Namely, as the molecules are orientated at least one of the length direction and the widthwise direction, the film has large degree of polarization and the Rth. This is the reason that the film having 35 μm to 65 μm thickness can be used for a wide viewing angle film as the conventional film having 80 μm thickness.

(3) Retardation In-Plane (Re)

In this embodiment, when the casting direction of the dope is positive and a retardation in-plane (it is referred as Re in the following) is in a range of −50 nm to 5 nm, the cellulose ester film (especially TAC film) can be used as an optical film, such as a protective film for a polarizing filter and an optical functional film (e.g. a wide viewing angle film). The Re is formulated as follows.

Re=(nx−ny)×d (2)

Note that “nx”, “ny” and “d” are the same as the formula (1).

(4) Measurement of Infrared Absorption Spectrum

In FIG. 5, the inventors of the present invention found that the tear strength of the film becomes at least 6 g when there is a peak A1 in the wavenumber range A (from 520 cm⁻¹ to 480 cm⁻¹). It is considered that the increase of strength of the film is due to crystallization of polymer in the film. The inventors also found that the tear strength is related to an absorbance intensity in the peak A1. In order to obtain the absorbance intensity, a tangent line as a base line “b” of the peak A1 is used. According to the value of the absorbance, “It” and “Ib” are determined as the maximum absorbance (peak top) and the minimum absorbance of the peak A1. The minimum absorbance Ib is a value of absorbance at a point b1 on a base line “b”, while the wavenumber of the point b1 is the same that of the maximum absorbance. The differential (It−Ib) is determined as IR peak intensity. It is found that strength of the film increases, as the IR peak intensity is high.

For comparison, FIG. 6 shows the infrared absorption spectra of the cellulose ester film which is produced in the conventional method. As shown in FIG. 6, there is a shoulder peak A2 in the wavenumber range A. However, the shoulder peak A2 is not clearly recognized. Accordingly, crystallization of polymer does not proceed in the conventional cellulose ester film.

In the solution casting method as mentioned above, the dope is cooled to form a gel-like film, which is peeled from the substrate. During formation of the gel-like film, a core (microcrystal) is formed such that polymer may perform easy rearrangement in the following processes. Note that the core (microcrystal) thereof is the micro area of polymers in which crystallization of polymer is easily rearranged. During dry and tension, the cellulose ester (particularly TAC) is rearranged to form the film. Optimizing at least one condition of dry and tension can produce an arbitrary film, namely a film having arbitrary hardness (e.g. tear strength) or optical property (e.g. value of retardation). Moreover, measuring IR spectrum on-line makes it possible to quantify the physical properties of the film on-line. As a result, it is possible to optimize a film production process efficiently.

According to the present invention, an experiment was made and explanation therefor will be made. However, the present invention is not limited to this explanation. The producing method of the cellulose ester film is explained in the example 1 in detail. The same explanation will be omitted in the examples 2-5 and comparisons 1-4. At first, preparation of dope, and then the film producing method will be mentioned. Further, as for the condition and result of evaluation in this example is shown in Table 1.

### EXAMPLE 1

(Preparation of Dope)

To make a dope for producing a film, the following compounds are prepared by the above producing method.

| | | |
|---|---|---|
| cellulose acetate (acetyl value of 62%) composed of wood | 20 | pts. wt. |
| pulp | | |
| plasticizer (TPP:BDP = 2:1) | 2.2 | pts. wt. |
| UV absorbent (2,4-bis-(n-octylthio)-6-(4-hydroxy-3, | 0.4 | pts. wt. |
| 5-di-tert-butyl anilino)-1,3,5-triazine) | | |
| dichloromethane | 64 | pts. wt. |
| methanol | 16 | pts. wt. |
| n-buthanol | 4 | pts. wt. |

Weight ratio of the solvent to the solid content of the dope was approximately 372 wt. %.

(Production of the Film)

The film production line 10 in FIG. 1 was used for producing the film 23. The dope 12 is cast from the casting die 16 onto the drum 17 cooled to −5° C. at the cast speed of 60 m/min so as to obtain the film 23 having a thickness of 40 μm after drying. The dope 12 is cooled while it is fed for 10 seconds on the drum 17 and peeled by the peeling roller 21 as the gel-like film 20. Thereby, a part of the gel-like film 20 is cut off and used for measuring a weight ratio of the solvent to a solid content of the gel-like film 20. The weight ratio was 220 wt. %. The gel-like film 20 is dried in the tenter drier 22 to contain 100 wt. % of the solvent. Thereafter, both sides of the gel-like film 20 were tensed at 60 kg/m by the tenter drier 22. Temperature inside the tenter drier 22 is adjusted such that the surface temperature of the gel-like film 20 may be 120° C. inside the tenter drier 22.

In the tenter drier 22, the gel-like film 20 forms the film 23 having self-support property, and the film 23 is fed out towards the dry zone 25, where temperature is controlled in a range of 120° C. to 145° C. The film 23 was fed in the dry zone 25 for 12 minutes, and thereafter cooled to room temperature in the cooling zone 26. Then, infrared absorption spectrum of the film is measured by the infrared spectrophotometer 30. And finally the film 23 is wound by the winding device 29.

{Evaluation of The Film}

The infrared absorption spectrum of the cellulose ester film 23 is measured by the infrared spectrophotometer 30. The IR spectrum of the wavenumber range A was 0.1. A Fourier transform infrared spectrophotometer FTIR 350 produced by JASCO Corporation is used in the present invention. A DSW010 is used for on-line measurement as a web sensor, and it is connected to the Fourier transform infrared spectrophotometer through the optical fiber. The tear strength of the film was 12.0 g. Further, the Rth was 42 nm and the Re was 1.2 nm. As a result, the film having excellent hardness and an optical property were obtained (O).

### EXAMPLE 2

The Example 2 conducts an experiment under the same condition as the Example 1 except that surface temperature of the gel-like film 20 is set to 135° C. inside the tenter drier 22. The result of the Experiment is illustrated in Table 1.

### EXAMPLE 3

The Example 3 conducts an experiment under the same condition as the Example 1 except that the tension to the gel-like film is 120 kg/m. The result of the Experiment is illustrated in Table 1.

### EXAMPLE 4

The Example 3 conducts an experiment under the same condition as the Example 1 except for temperature of the drum is 5° C. The result of the Experiment is illustrated in Table 1.

### EXAMPLE 5

In the Example 3, experiments under the same condition as the Example 1 is conducted except that the dope is cast to obtain the film whose thickness after drying is 60 μm and the tension to the gel-like film is 90 kg/m.

{Comparison 1}

In the Comparison 1, an experiment under the same condition as the Example 1 is conducted except that the surface temperature of the gel-like film 20 is kept 70° C. and tension is applied to 100 kg/m in the tenter drier 22. The tear strength of the film was 5.0 g. The Rth and the Re were 30 nm and 0.5 nm respectively. The film having weak strength and some disadvantages in optical property (x).

{Comparison 2}

In Comparison 2, experiments are carried out under the same condition as the Example 1 except that the dope is cast to obtain the film having 40 μm thickness after drying, the surface temperature of the gel-like film 20 is kept 70° C. and the tension is set to 300 kg/m in the tenter drier 22. The result is shown together in Table 1. As the film is targeted to have 40 μm film thickness and 300 kg/m tension in the Comparisons, the gel-like film is severed during producing. Accordingly, the film can not be produced, to say nothing of evaluating the film.

{Comparison 3}

In comparison 3, experiments are carried out under the same condition as the Example 1 except that temperature of the drum 17 is set as 15° C. The result is shown together in Table 1

{Comparison 4}

In comparison 4, experiments are carried out under the same condition as the Example 1 except that temperature of the drum 17 is set as 15° C., temperature of the surface of the gel-like film 20 is set as 70° C. and the tension is 20 kg/m in the tenter drier 22. The result is shown together in Table 1.

TABLE 1

| | TOD | TOG | TTG | TOF | IR | TS | Rth | Re | |
|---|---|---|---|---|---|---|---|---|---|
| | (° C.) | (° C.) | (kg/m) | (μm) | peak | (g) | (nm) | (nm) | EST |
| Ex. 1 | −5 | 120 | 60 | 40 | 0.1 | 12.0 | 42 | 1.2 | ∘ |
| Ex. 2 | −5 | 135 | 60 | 40 | 0.13 | 15.0 | 50 | −1.5 | ∘ |
| Ex. 3 | −5 | 135 | 120 | 40 | 0.21 | 18.0 | −12 | −2.2 | ∘ |
| Ex. 4 | 5 | 120 | 60 | 40 | 0.08 | 10.0 | 39 | 1.9 | ∘ |
| Ex. 5 | −5 | 120 | 90 | 60 | 0.14 | 15.0 | 52 | 2.0 | ∘ |
| Com. | −5 | 70 | 100 | 40 | none | 5.0 | 30 | 0.5 | x |
| 1 | | | | | | | | | |
| Com. | −5 | 70 | 300 | 40 | — | — | — | — | — |
| 2 | | | | | | | | | |
| Com. | 15 | 120 | 60 | 40 | 0.02 | 5.5 | 32 | 0.6 | x |
| 3 | | | | | | | | | |
| Com. | 15 | 70 | 20 | 40 | none | 5.0 | 25 | 10 | x |
| 4 | | | | | | | | | |

TOD is temperature of a drum.
TOG is temperature of a gel-like film.
TTG is tension to a gel-like film.
TOF is thickness of a film.
TS is tear strength of a film.
Rth is retardation in thickness direction of a film.
Re is retardation in-plane of a film.
EST is estimation of a film.
In the compared example 2, film could not be produced.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A cellulose ester film comprising a property of:
a peak of infrared absorption spectrum being in a range from 520 cm⁻¹ to 480 cm⁻¹.

2. A cellulose ester film as claimed in claim 1, further comprising a property of:
retardation in thickness direction (Rth) being at least 35 nm.

3. A cellulose ester film as claimed in claim 2, further comprising a property of:
retardation in-plane (Re) being in a range of −50 nm to 5 nm, wherein a feeding direction in producing said cellulose ester film is a positive direction.

4. A cellulose ester film as claimed in claim 3, wherein the thickness of said cellulose ester film is in a range of 35 μm to 65 μm.

5. A cellulose ester film as claimed in claim 4, wherein said cellulose ester is cellulose acylate.

6. A cellulose ester film produced by casting a dope containing cellulose ester and a solvent, said cellulose ester film comprising a property of:
a tear strength being at least 6 g.

7. A cellulose ester film as claimed in claim 6, further comprising a property of:
a peak of infrared absorption spectrum being in a range of 520 cm⁻¹ to 480 cm⁻¹.

8. A cellulose ester film as claimed in claim 7, further comprising a property of:
retardation in thickness direction (Rth) being at least 35 nm.

9. A cellulose ester film as claimed in claim 8, further comprising a property of:
retardation in-line (Re) being in a range of −50 nm to 5 nm, wherein a feeding direction in producing said cellulose ester film being a positive direction.

10. A cellulose ester film as claimed in claim 9, wherein said cellulose ester film is in a range of 35 μm to 65 μm thickness.

11. A cellulose ester film as claimed in claim 10, wherein said cellulose ester is cellulose acylate.

12. A producing method of a cellulose ester film comprising the steps of:
A. casting a dope on a substrate from a casting die to form a gel-like film, said dope containing a solvent and solid contents such as cellulose ester;
B. peeling said gel-like film from said substrate;
C. regulating temperature of said gel-like film in a range of 80° C. to 140° C. when the content of said solvent in said gel-like film is in a range of 20 wt. % to 100 wt. % to said solid contents, said gel-like film forming said cellulose ester film after dry.

13. A producing method of a cellulose ester film comprising the steps of:
A. casting a dope on a substrate from a casting die to form a gel-like film, said dope containing a solvent and solid contents such as cellulose ester;
B. peeling said gel-like film from said substrate;
C. applying tension of 25 kg/m to 250 kg/m in a widthwise direction of said gel-like film when the content of said solvent in said gel-like film is in a range of 20 wt % to 100 wt. % to said solid contents, said gel-like film forming said cellulose ester film after dry.

14. A producing method of a cellulose ester film as claimed in claim 13, temperature of said gel-like film ranges from 80° C. to 140° C. in said step C.

15. A producing method of a cellulose ester film as claimed in claim 14, said dope is cooled to have a temperature of at most 5° C. in said step A.

16. A producing method of a cellulose ester film, an infrared absorption spectrum of said cellulose ester film having a peak in a range of 520 cm⁻¹ to 480 cm⁻¹, a tear strength being at least 6 g, and retardation in thickness direction (Rth) being at least 35 nm, said producing method comprising the steps of:
A. cooling a substrate to have temperature at most 5° C.;
B. casting a dope on said substrate from a casting die section to form a gel-like film, said dope containing a solvent and solid contents such as cellulose ester;
C. peeling said gel-like film out of said substrate;
D. applying tension in a range of 25 kg/m to 250 kg/m to a widthwise direction of said gel-like film when the content of said solvent in said gel-like film is in a range of 20 wt % to 100 wt. % to said solid contents, said gel-like film forming said cellulose ester film after dry.

17. A producing method of a cellulose ester film as claimed in claim 16, wherein temperature of said gel-like film ranges from 80° C. to 140° C. in said step D.

18. A producing method as claimed in claim 17, further comprising the steps of:
measuring infrared absorbance in said cellulose ester film after said step D to obtain a peak intensity in a range of 520 cm⁻¹ to 480 cm⁻¹;
adjusting temperature or tension of said gel-like film of said step D in accordance with said peak intensity.

19. A producing method of a cellulose ester film as claimed in claim 17, wherein said gel-like film has a multi-layer structure.

20. A producing method of a cellulose ester film as claimed in claim 19, wherein said casting die section is a multimanifold casting die having plural manifolds.

21. A producing method of a cellulose ester film as claimed in claim 19, wherein said casting die section is a casting die having a feed block on an upstream side to a flow of said dope.

22. A producing method of a cellulose ester film as claimed in claim 19, wherein said casting die section includes plural casting dies.

23. A producing method of a cellulose ester film as claimed in claim 19, wherein the thickness of said cellulose ester film is in a range of 20 μm to 120 μm.

24. A producing method of a cellulose ester film as claimed in claim 23, wherein said cellulose ester is cellulose acylate.

25. A producing method of a cellulose ester film as claimed in claim 24, wherein said cellulose ester film is used for a protective film for a polarizing filter.

26. A producing method of a cellulose ester film as claimed in claim 24, wherein said cellulose ester film is used for an optical functional film.

27. A producing method of a cellulose ester film as claimed in claim 24, wherein said cellulose ester film is used for a polarizing filter.

28. A producing method of a cellulose ester film as claimed in claim 24, wherein said cellulose ester film is used for a liquid crystal display device.

29. A producing method of a cellulose ester film, said cellulose ester film being produced by casting a dope containing a solvent and solid contents such as cellulose ester to form a gel-like film and by drying said gel-like film with applying tension on it, said producing method comprising:
measuring infrared absorbance in said cellulose ester film during continuous production to obtain a peak intensity in a range of 520 cm⁻¹ to 480 cm⁻¹; and
adjusting temperature of said gel-like film for drying and said tension of said gel-like film in accordance with said peak intensity.
